(19) United States
(12) Patent Application Publication
(10) Pub. No.: US 2006/0187478 A1
(43) Pub. Date: Aug. 24, 2006

(54) Online method and system for converting any file in any format into a pdf file for various uses

(75) Inventors: Phil Kongtcheu, Jersey City, NJ (US); Vincent Demarcus, Paris (FR)

Correspondence Address: PHIL KONGTCHEU;PFK TECHNOLOGIES, 1866 JOHN F. KENNEDY BOULEVARD SUITE B1, JERSEY CITY, NJ, 07305, US

(73) Assignee: Phil Kongtcheu, Jersey City, NJ (US)

(21) Appl. No.: 10/544,456

(22) PCT Filed: Mar. 3, 2003
(86) PCT No.: PCT/US03/06266

§ 371 Date: Aug. 4, 2005

Related U.S. Application Data
(60) Provisional application No. 60/444,257, filed on Feb. 3, 2003.

(51) Int. Cl. G06F 3/12

(52) U.S. Cl. 358/1.13; 358/1.15

(57) ABSTRACT

A method and system for enabling the conversion of the printable content of any file document in any file format type (1) from a client computer to a Portable Document Format (PDF) file (2) created on a central server. The system allows for secure sharing or subsequent electronic submission of the converted document (2). The system also provides improved technology for an alternative method for online printing and online document submission for various applications including proposal submissions, patent application submissions and online mail submissions.

### BACKGROUND OF THE INVENTION

With the enactment of E-Sign Law in the United States and similar laws worldwide, various federal agencies in the US and the world increasingly rely on electronic submission, storage, and sharing of documents once handled by paper. This has led to widespread use of the PDF format as a standard for reliability in reproducing the contents of paper documents as well as a standard for viewing printable documents on all types of computers. Often documents submitted are to meet critical deadlines where seamless and predictable conversion of working files into the proper format is crucial. Where conversion fails, a grant proposal may be denied consideration, documents may not be given legal effect, and the use of recently introduced online postal technologies and services for sending letters and other documents may become distrusted. These are just a few examples where the failures of the existing technologies can lead to lost business opportunities, increased cost in business operations, and unnecessary frustrations. Furthermore, even where the existing technologies work, the number of formats that can be converted to PDF files is limited and inadequate to address the wide range of possible users needs. The present invention solves these critical failures by artfully using in combination select affordable yet reliable technologies.

A prior art review of commercially available products reveals Adobe Systems Inc. and Amyuni Technologies as providers of comparable technologies in the field of our invention. As will be discussed however, these technologies do not overcome certain problems frequently and commonly faced when documents and printable materials are shared, submitted, or otherwise handled between different parties or organizations.

What Adobe provides is the Adobe 5.0 software, which is sold with the Adobe PDF Writer™ applications and Adobe Distiller™ applications. The Adobe products claim to enable conversion and editing of the content of any type of document into PDF files.

A major benefit of our invention as compared to the technologies embedded in the products listed above is that:

1) Contrary to the Adobe PDF Writer™ and Adobe Distiller™ applications or Amyuni PDF converter applications, which require a new software installed on the desktop computer for each new operating system (OS), our invention can be readily used with any OS implementing the Internet Printing Protocol (IPP), since all major OSs have this protocol implemented or have free enabling software patches. Therefore, to illustrate the complication of using these existing products, one software application must be bought for a Windows® OS and another software application must be bought for a Linux® OS, even though those different OSs may be installed on the same computer. In fact, any new OS will require additional software to enable use of the other existing technologies. In contrast, our invention is based on an application service provider model and therefore allows the user to create PDF documents from any OS. Users of the technology taught in our invention need only configure a new network printer with the IPP protocol available on their computers and take advantage of a general printing format such as the postscript format, a capability provided for by all major OSs. This facility is substantially less cumbersome than designing new software for each new OS. None of Adobe® PDF Writer and Adobe Distiller applications nor the Amyuni PDF Converter™ applications have a comparable capability.

2) More importantly, our invention enables users to submit, share, or otherwise handle documents or printable materials from any file format, from any workstation, at anytime, and allow a server to produce a PDF file therefrom. In contrast, prior art technologies suffer from the inability to be universally applicable to any file format. The limitations of the prior art technologies is exemplified by the Create Adobe® PDF Online service available at http://createpdf.adobe.com, a service that enables online PDF document creation. As will be further detailed below, the major problem of that service is its inability to handle all file formats. In fact, all applications surveyed, which need to embed ancillary technologies to enable submission of printable content in any file format, from any location, at anytime, in order for a server to produce the PDF file, face the same limitations as the Create Adobe® PDF Online service.

A prior art search of the term “PDF document creation” in the title or abstract was performed in an aggregating database of patents provided by the Patent Search Made Easy™ service of the AgoraIP™ Website. This database searches through all published patents, all US patent applications for the last two years, all Japanese Patents since 1978, all European patents and WIPO Patents since 1978, all Canadian Patents since 1920, and over 70 other patent offices databases as provided by the Espacenet™ website. The search returned 3 results of which WIPO patent number WO 02/01403 and Japanese Patent Publication Number JP2002318797 appeared to be relevant. WO 02/01403 pertains to a method and system for creating and ordering customized printing material on-line via a network for data-communication. WO 02/01403 teaches the submission of documents to be printed in two distinct XML files, one being the text content of the document and the other being the design template of the document. In doing so WO 02/01403 does not address the central problem solved in our invention—that is, enabling document submission in any file format. Furthermore, our invention easily enables the achievement of its goals through our online PDF document manipulation feature through which a template PDF file may be created and appended to the text file as a background or foreground watermark. This capability is enabled in our I-PDF Edit™ service of the AgoraIP™ website.

JP2002318797 describes a method for transforming a printable document generated by a mainframe computer into a document of equivalent representation when viewed or printed from a desktop computer. The main focus of JP2002318797 is addressing font distortions that may occur. Although JP2002318797 uses the PDF format to preserve printing results, the technology taught in JP2002318797 does not teach nor enable the specific advances disclosed in our invention.

As far the application of the present invention to online printing is concerned, our prior art search included the search of the patent portfolio of the Company Mimeo, Inc., a leading provider of online printing services. The search in the WIPO database returned three results, two of which were directly related to printing:

WO0135312: System, method and recordable medium for printing services over a network and graphical user interface;

WO0135207 System, method and recordable medium for printing services over a network

Contrary to our invention however, none of the specifications of those two patents involved the use of the PDF format. Furthermore, both Mimeo patents involved installing a software printer driver on the client computer and both patents' use of the Internet Printing Protocol is unclear.

### BRIEF SUMMARY OF THE INVENTION

This invention relates to an online method and system for creating PDF documents from printable files of any format. It represents an improvement over existing technologies, which are limited in two key aspects: either they enable PDF document creation for all file formats only as desktop software applications, or they enable online PDF document creation as an application service provider only for a limited set of file formats. As a result, the use and reliability of the prior art technologies is limited for many practical applications. In contrast, our invention is useful for many applications, including but not limited to enabling reliable online printing from electronically submitted material and enabling online submissions. For example, the technologies taught in this invention will enable improvements in the convenience, simplicity, and effectiveness of making electronic patent application submissions. The invention also enables improved methods and systems for electronic submission of documents for online posting. Additionally, the invention can be implemented to improve existing electronic services developed by postal services. An additional example of where this invention can be used is the electronic submission of proposals to granting institutions or general online PDF document creation. These examples are not limiting, but are included only to illustrate the many potential uses for the technology taught in this invention.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 details the substance of our invention. FIGS. 2-14 and 16 further show the novelty, usefulness and non-obviousness of our invention by contrasting its advantages over the limitations of high-end solutions currently available.

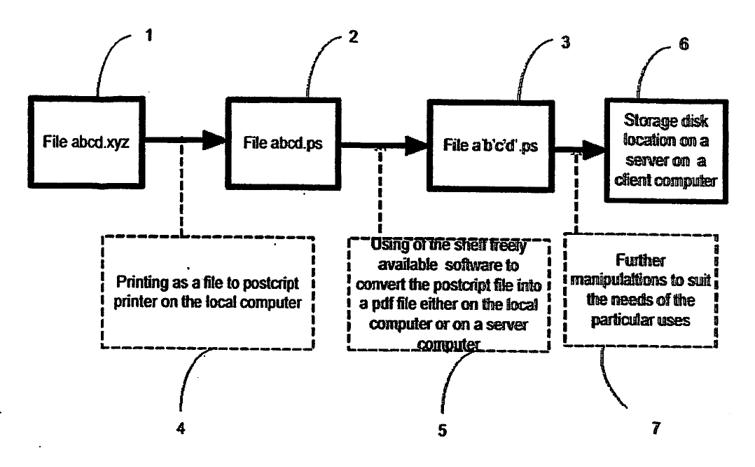

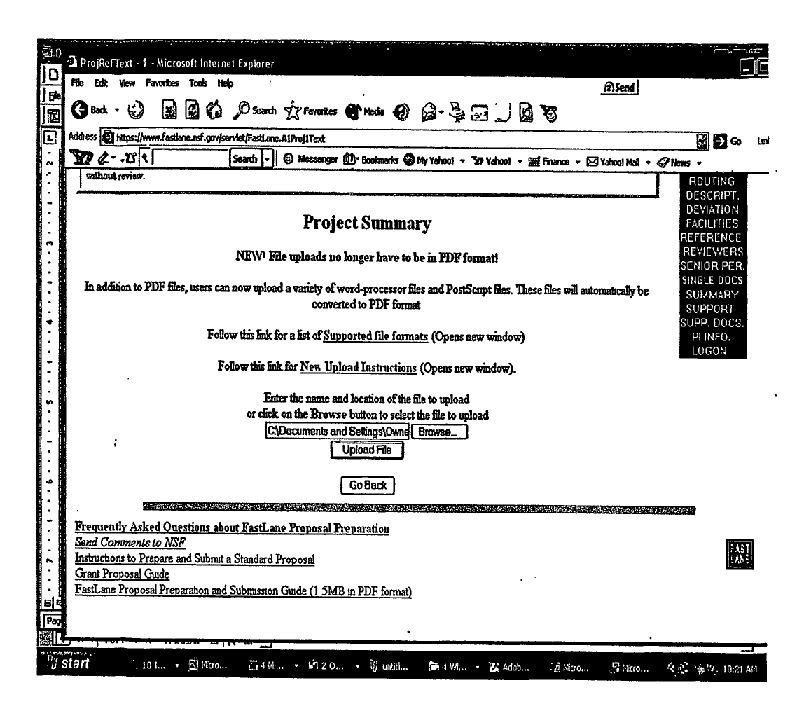

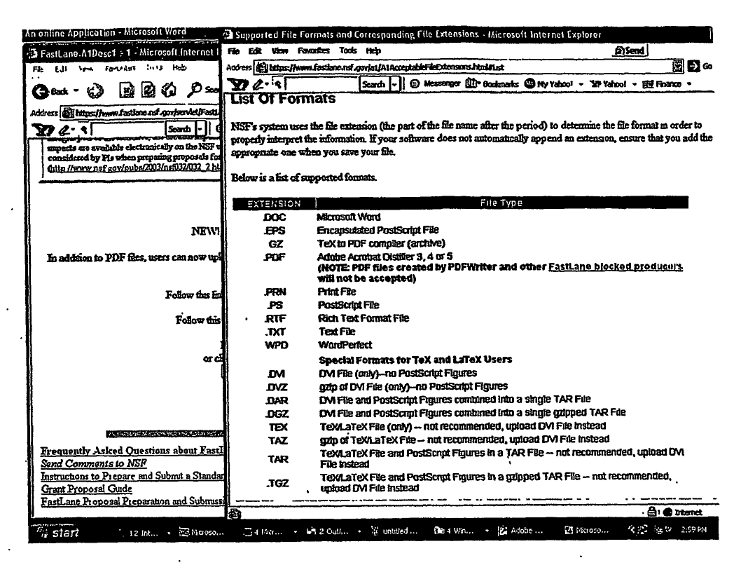

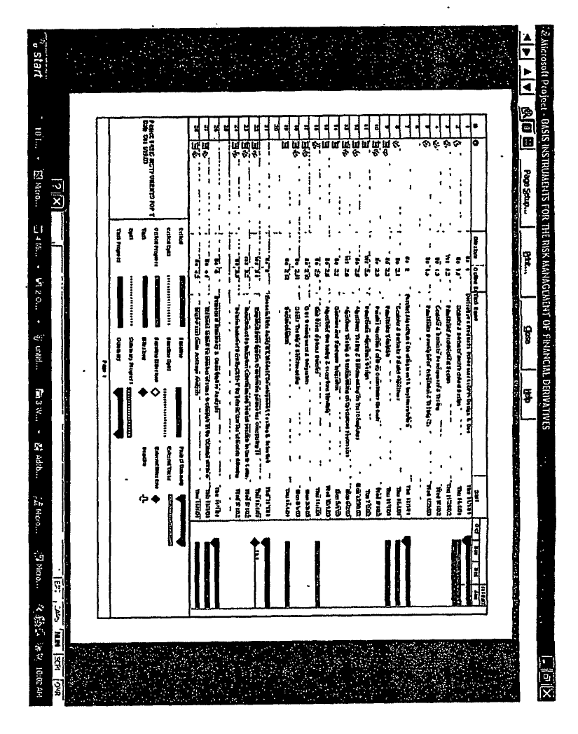

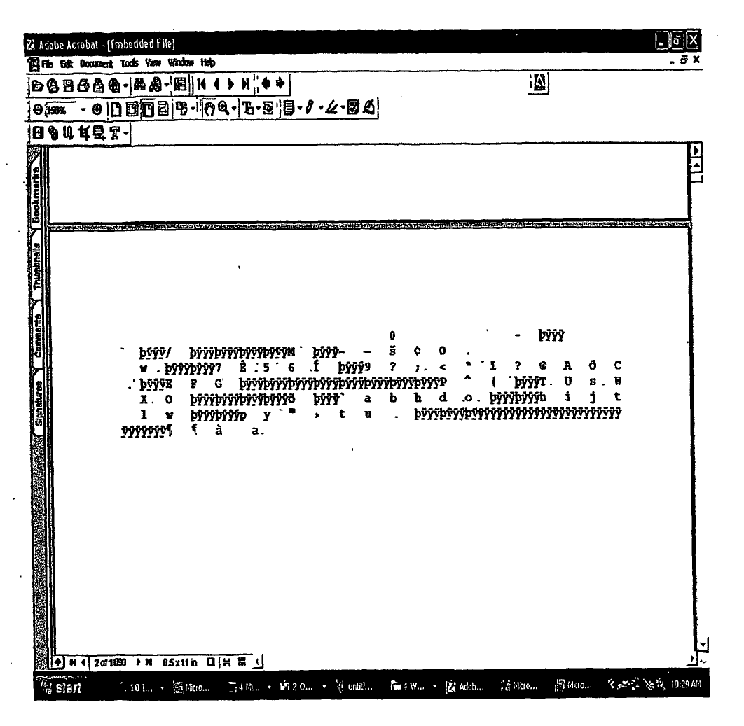

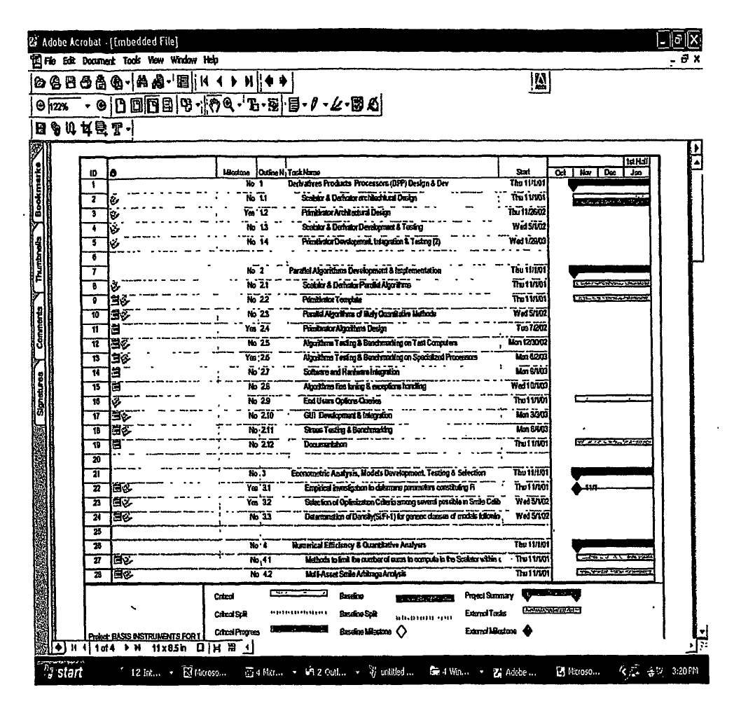

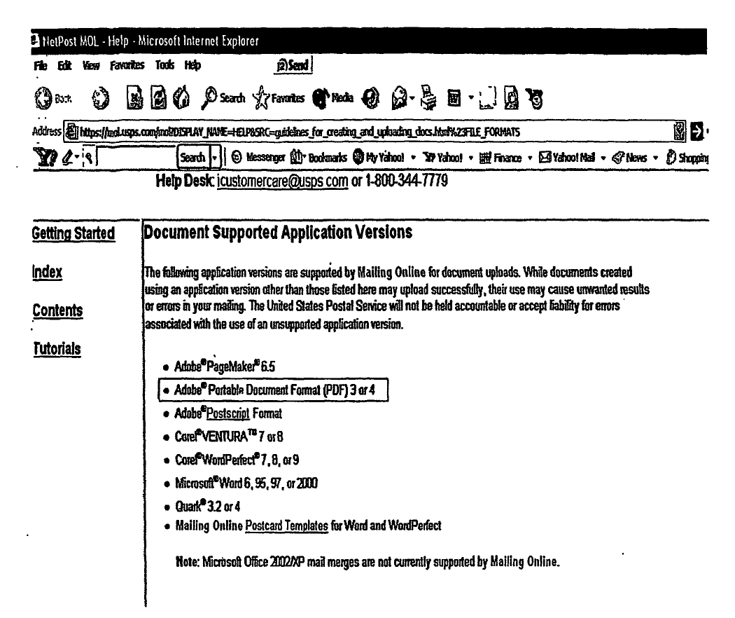

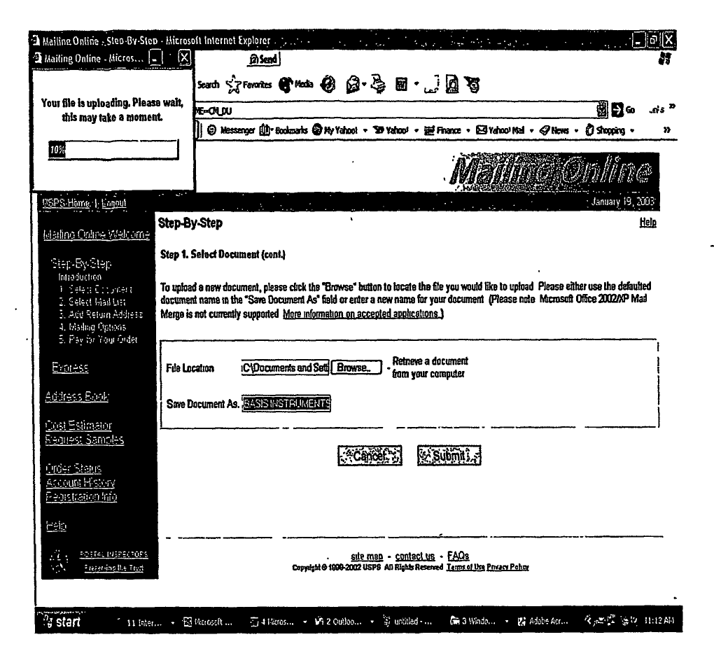

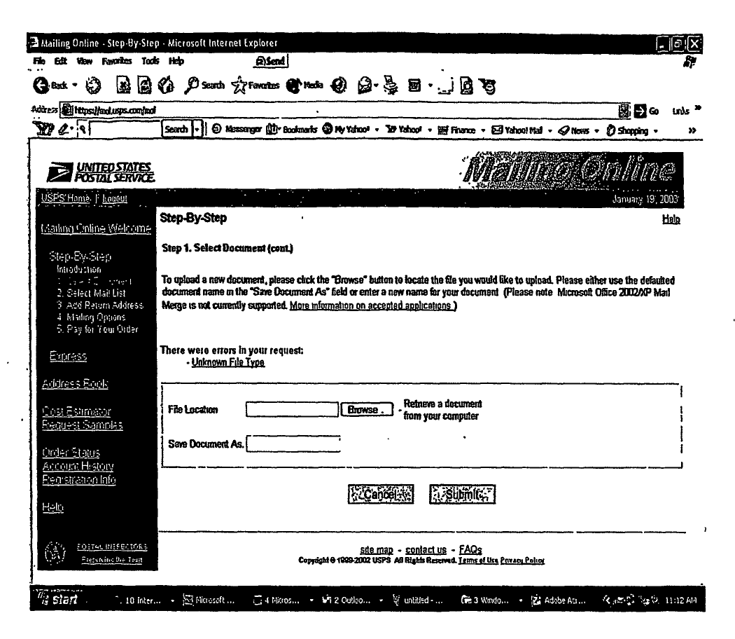

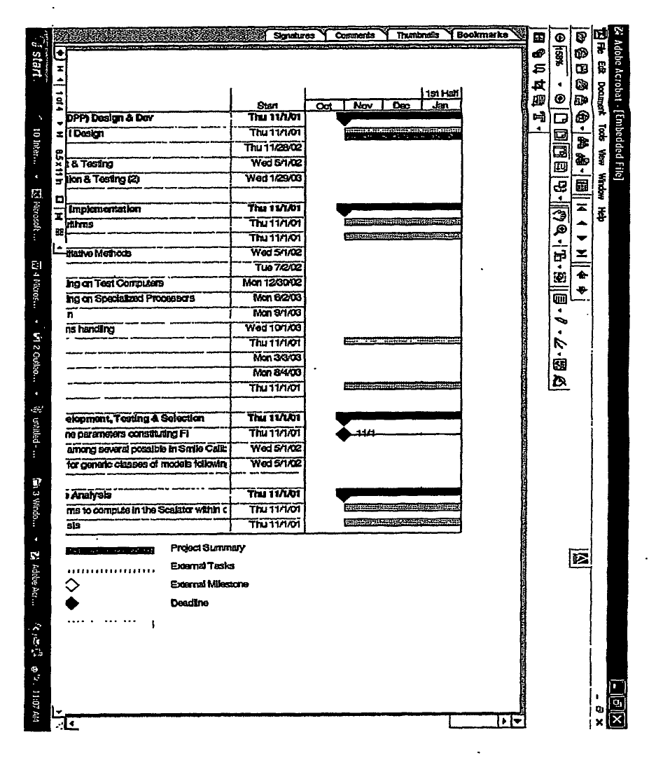

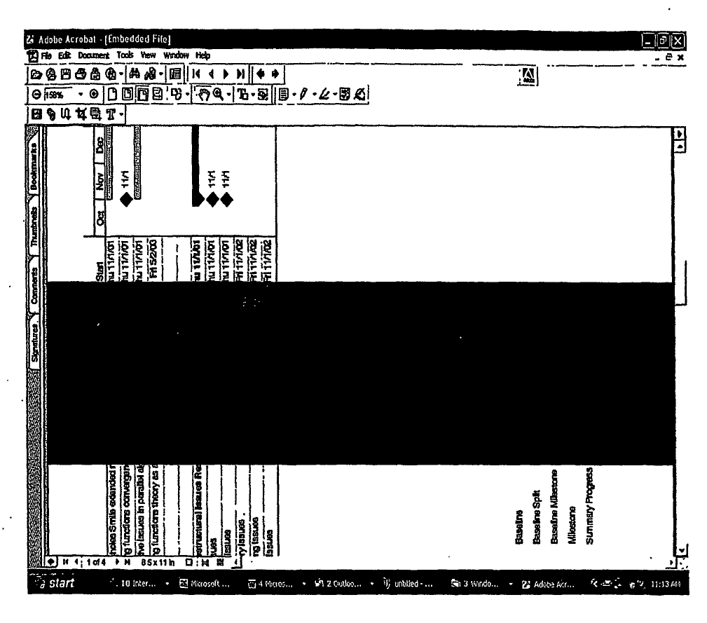

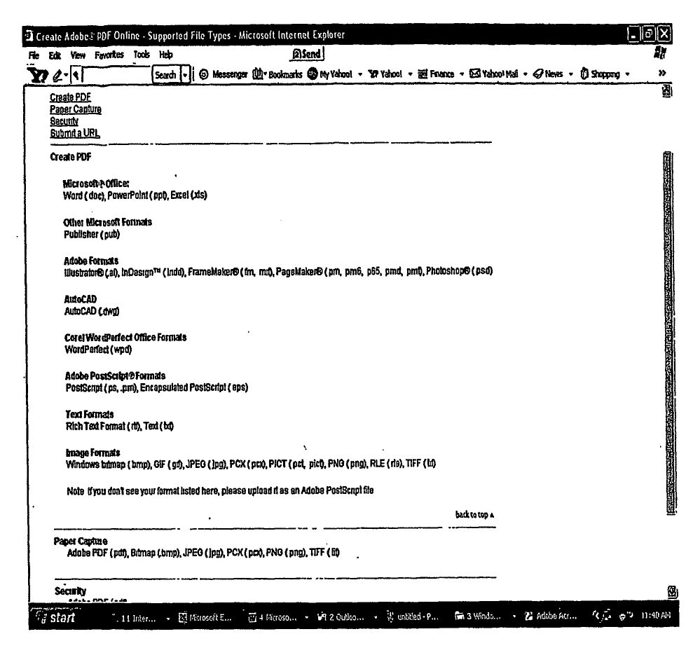

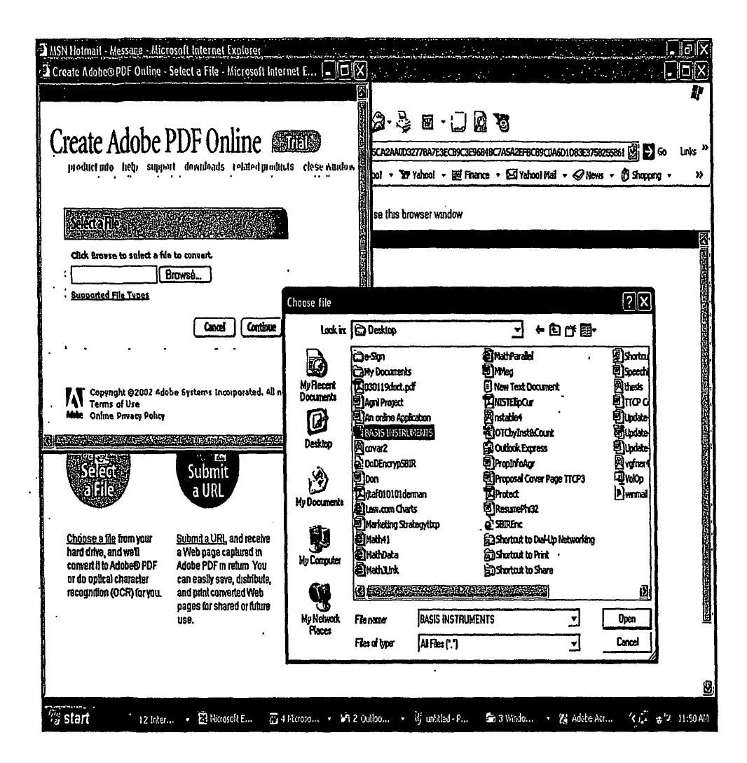

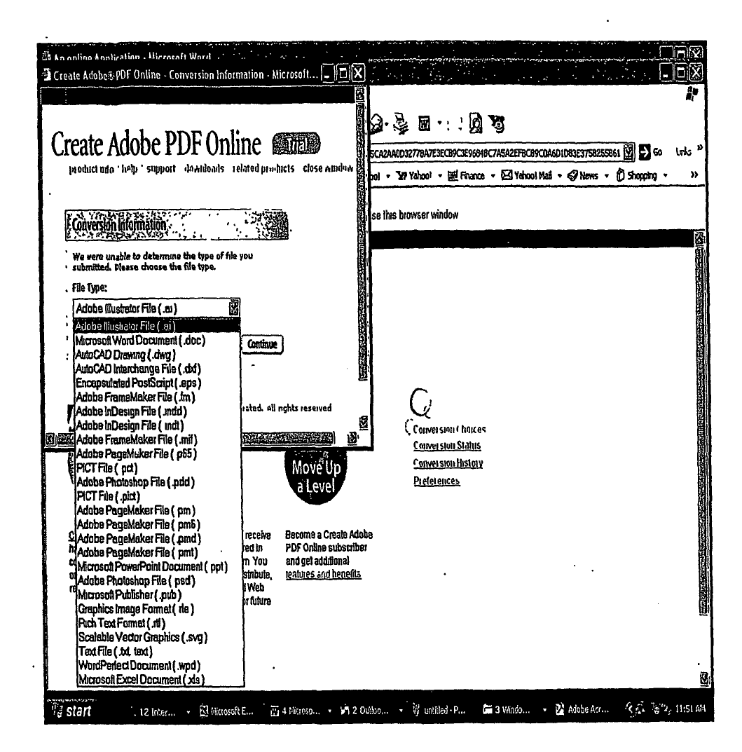

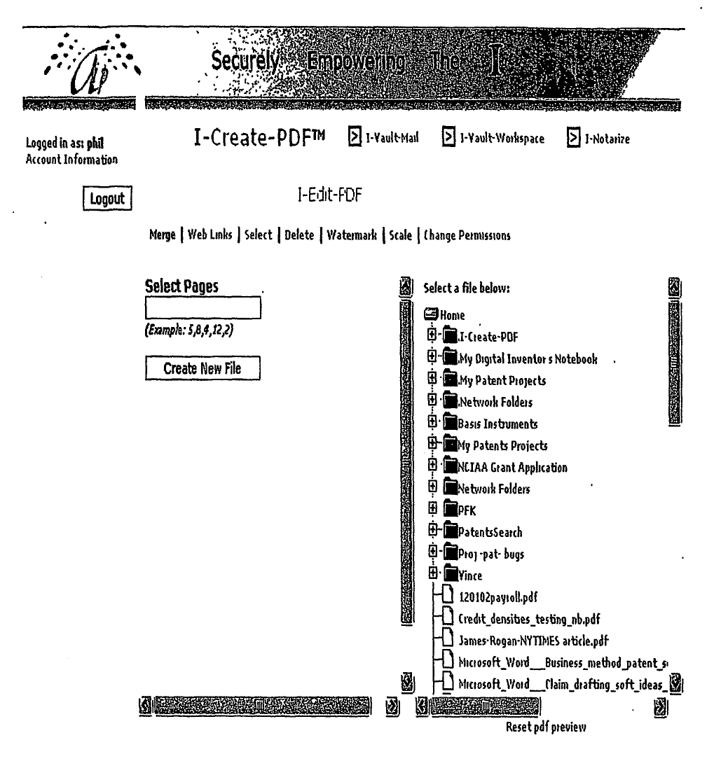

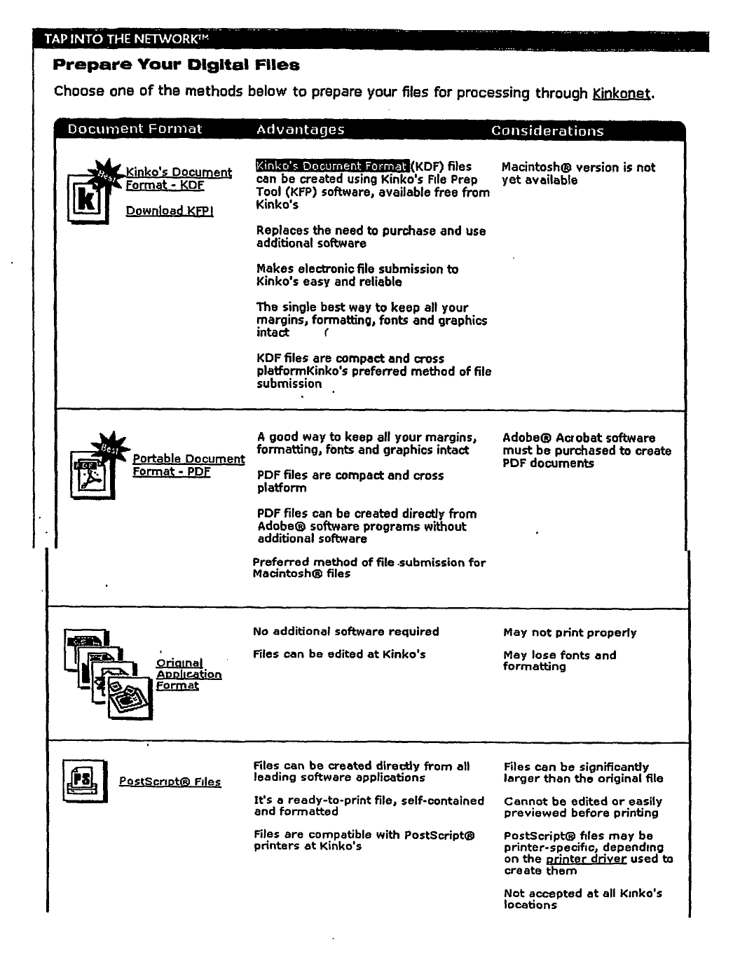

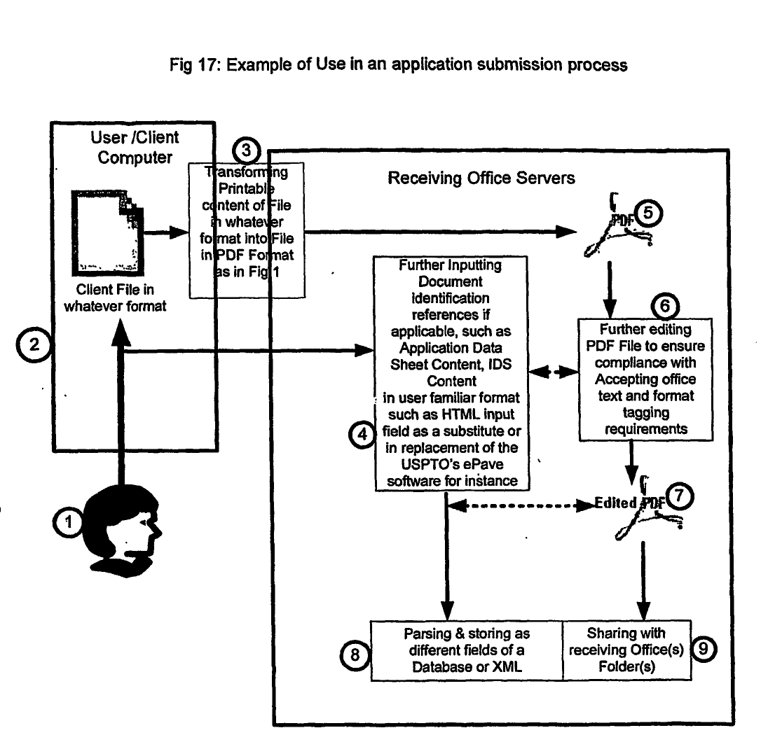

FIG. 1 shows a flow diagram and description of the essential steps of our invention and is divided in 7 parts:
1 is any file of any possible extension format symbolized by .xyz that a user may want to share with a recipient or merely convert into a PDF file for an unspecified need.
2. is the initial abcd.xyz file converted via printing means to a second file abcd.ps as shown in 4. This is achieved using the postscript standard that is commonly available as a printer driver in most computers. The file is subsequently sent to a server or desktop application.
3. is the abcd.ps file converted to a PDF file using a readily available software such as ghostscript (as shown in 5) either on the desktop or a server computer.
6. is the location where the output file is stored.
In 7, further manipulations include but are not limited to renaming, copying, moving, concatenating the produced PDF file to obtain a file suitable to the purpose at hand. For instance in a National Science Foundation (NSF) file proposal submission, the obtained file may be further concatenated with files of other sections of the proposal, or stored in particular server locations for easier retrieval, or secured for limiting tampering possibilities.

FIG. 2 shows a picture of the Fastlane™ uploading mechanism.

FIG. 3 shows a picture of the NSF Fastlane™ supported format types as provided on the Fastlane website (http://www.fastlane.nsf.gov).

FIG. 4 shows an original Microsoft Project™ file in print preview mode.

FIG. 5 shows a picture of one page of 1090 pages of garbage generated by the Fastlane™ system upon attempted conversion of a Microsoft Project™ file.

FIG. 6 shows a picture of the result of the Microsoft Project™ file using our file conversion invention as implemented in the I-PDF-Create™ section of the AgoraIP.com website.

FIG. 7 shows the limited set of file formats supported by the United States Postal Service (USPS) online mailing system.

FIG. 8 shows a picture of the Microsoft Project™ file attempt at uploading in the USPS system.

FIG. 9 shows a picture of the response of the USPS uploading system for the Microsoft Project™ file. The current USPS system could not handle the file type.

FIGS. 10 and 11 show the result of the PDF files version 3 after upload in the USPS system. While the first page as shown in FIG. 10 appears to have been successfully uploaded, the second page as shown in FIG. 11 displays a large undesirable black strip on the page showing unreliability of the system.

FIG. 12 shows the limited set of file types allowed in the Adobe online PDF file conversion system as shown at https://createpdf.adobe.com.

FIG. 13 shows an attempt to convert a Microsoft Project™ file in this online Adobe system.

FIG. 14 shows the anticipated conversion failure by the Online Adobe Conversion system.

FIG. 15 shows a picture of a service of the AgoraIP™ website actually implementing step 5 of preferred embodiments of the present invention.

FIG. 16 shows a picture of the description on the Kinko's™ website of methods of submission of files for printing in the absence of an invention such as ours.

FIG. 17 details an embodiment of our invention in a patent submission process.

### DETAILED DESCRIPTION OF THE INVENTION

The following section details the implementation of the present invention in various applications. Steps 1 through 3 serve to elucidate a core mode of application and a preferred embodiment. Steps 4 through 7 each illustrate an additional embodiment. Finally, examples for uses of this invention are illustrated and contrasted with the limitations inherent in existing prior art technologies.

The embodiments and examples that follow are merely intended to illustrate a few areas of applicability. The concepts taught are broadly applicable to uses beyond those of the examples and embodiments recited below. The broad applicability of this invention will be evident to those skilled in the art upon reading the enabling disclosure below. Additional elucidation is included in the Appendix that follows the embodiments and examples.

A preferred embodiment of the present invention contains the following steps:

Step 1: A file is printed into a postscript printer file

Step 2: The postscript printer file is sent through a secure socket on a given port (e.g. port 631) using the Internet printing protocol to a central server

Step 3: The central server takes the postscript file and uses readily available software such as ghostscript to convert the postscript file into a PDF file.

Step 4: Another preferred embodiment of the present invention may further comprise saving the created PDF file in a user-accessible designated folder on the central server.

Step 5: Another preferred embodiment of the present invention may further comprise further manipulating the PDF file using a PDF editing application service providing system on a central server. Such manipulations include but are not limited to merging PDF Documents, adding e-mail or webpage links to PDF documents, extracting specific pages, deleting pages, front or back watermarking a PDF document.

Step 6: Another preferred embodiment of the present invention may further comprise using front or back watermarking of a PDF document to append document templates to a first PDF document

Step 7: Another preferred embodiment of the present invention further comprises printing the generated PDF file on a user-designated networked printer or securely sharing the generated document with third parties in an online submission process

The concepts taught are broadly applicable to uses beyond those of the examples recited below, including, among others, online patent submission systems. The examples below are merely intended to illustrate a few areas of applicability of embodiments the present invention or problems in exiting methods, systems or computer programs that may be solved by embodiments of the present invention.

In summary, the advantages of the present invention include:

1. Online conversion of any file in any format into a PDF file

2. Facilitation of online document submission processes

3. Robustness, simplicity, security and dependability

4. Facilitation of online document sharing

5. Facilitation of online document printing

### Example 1

### The National Science Foundation (NSF) Fastlane™ System for Online Proposals Submission

The Fastlane™ system is a system for online submission of proposals to the National Science Foundation.

In the NSF Fastlane™ system, a submitter must upload the different sections of a proposal from the files in which they were prepared. Upon uploading, the files are converted to PDF documents and then concatenated to form a single file proposal that is in PDF format. The system is meant to facilitate easy retrieval and review by the program managers and proposal reviewers.

The problem with the present NSF system, which is solved in one embodiment of our invention, is the fact that not all file types can be uploaded and converted into PDF documents. In fact, many work file formats used by principal investigators (PI) in preparing their proposals may not be uploaded in the Fastlane™ system. One of the authors of the present invention had the very painful experience in 2001 of being disqualified from proposal consideration because the project description was prepared in Mathematica™. Wolfram Research, maker of Mathematica™ and the .nb Mathematica™ file extension claims to allow conversion of Mathematica™ files into tex files that are supposed to be transformable by the Fastlane™ system. This author faced, on the deadline date, the experience that the document produced was actually undecipherable garbage due to the limitations of the Fastlane™ conversion software system. As a result, the deadline was missed and the proposal was not reviewed.

Our invention, as further described in the detailed description below, overcomes the defects of the Fastlane™ system caused by the format conversion limitations described above.

FIG. 2 shows a picture of the Fastlane™ uploading mechanism.

FIG. 3 shows a picture of Fastlane™ supported format types as provided on the Fastlane™ website

FIG. 4 shows an original Microsoft Project™ file in print preview mode. FIG. 5 will show a failed attempted conversion of this file into a PDF format using the Fastlane™ file conversion system. FIG. 6. will show the successful conversion of this file into a PDF file using our system.

FIG. 5 shows a picture of one page out of 1090 pages of garbage generated by the Fastlane™ system upon attempted conversion of a Microsoft Project™ file.

This example thus generally illustrates our invention as an improved method for submitting proposals to corporate or governmental institutions worldwide. In such a process there would be no further limitations on the type of file formats to be used by a proposal submitter

### Example 2

### The United States Postal Service Online Posting System

The United States Postal Service has developed an online postal to allow mailing of document via electronic submission. This system allows submission of documents from a limited set of file formats.

Therefore, any electronic document in a format not belonging to this set of formats may not be handled by this system. In addition, even formats claimed to be supported may not produce an accurate printable version of submitted files.

Our invention as further described in the figures below will allow the postal service to handle all file format types and bring a level of reliability on which consumers can safely depend.

FIG. 7 shows the limited set of file formats supported by the USPS online mailing system. Note that we circled the PDF file format 3 or 4 below to indicate file formats claimed to be supported by this USPS system.

FIG. 8 shows a picture of the Microsoft project file attempt at uploading in the USPS system.

FIG. 9 shows a picture of the result as failed because of unknown file type.

FIGS. 10 and 11 show the result of the PDF files version 3 after upload in the USPS system. One can note that while FIG. 10, which is the first page of the uploaded PDF version 3 file, produces the intended result, FIG. 11, the second page, has an undesirable black strip making this service highly unreliable for everyday use.

This example thus generally illustrates our invention as an improved method and system for sending letters submitted electronically to recipients in remote locations throughout the world. In our invention, a user would scan or print documents to be delivered to a server. The server would then take the PDF document created as specified here and queue it to a printer at the requested destination available for the recipient to pick up. In contrast to existing methods of doing the same, the present invention is not limited in the file formats that may be submitted.

### Example 3

### Adobe

Adobe™ is the inventor of the Portable Document Format also known as PDF. Adobe has developed a system for online creation of PDF files. The Adobe™ system, however limits PDF transformation of only certain file format types. Furthermore, the Adobe™ system is quite unstable, as even permitted file types may not be converted if they further embed other applications such as Microsoft Visual Basic macros.

To illustrate, FIG. 12 shows the limited set of file types allowed in the Adobe Online PDF file conversion system. FIG. 13 shows an attempt to convert a Microsoft Project file in this online Adobe system. FIG. 14 shows the anticipated conversion failure by the Online Adobe Conversion system.

As illustrated in the I-PDF-Create™ method of the AgoraIP™ site, our invention is file format independent as well independent of further embedded applications. Our invention thus enables a more robust method of creating PDF documents online.

### Example 4

### Kinko's™

In a typical example, a consumer might go to the Kinko's™, Staples®, OfficeMax®, Office Depot® website and using the web application of our invention, submit a file of any file format type. The application would convert the file into a PDF file stored in a central server. The server would then queue the file for printing in another location where the consumer might go and pick it. In contrast to existing methods of doing the same, the present invention is not limited in the types of file formats that might be submitted.

As a good illustration of the benefits of the present invention, an online printing company seeking to allow users to print online would have the benefit of the present invention over the method currently provided by Kinko's™ of Kinko's Document Format (KDF) software. In the Kinko's™ application, a user must first download Kinko's™ proprietary software package as shown in FIG. 16. Then the user would convert the document into the proprietary Kinko's™ KDF format. The present invention eliminates the need to download any software; it eliminates the need to use a proprietary file format but rather generates the universal PDF format that Kinko's™ also accepts. Once the PDF document is obtained, it can them be easily printed with fidelity. As such this method enables online printing in a new and unique manner. So, if Kinko's™ were to use our invention, it would serve a larger customer base more extensively by providing them in addition with an online PDF creation application coupled if necessary with an online PDF manipulation application as illustrated for example in the I-PDF Create™ and I-PDF Edit™ services of the AgoraIP™ website as shown in FIG. 15.

Our invention thus enables an improved method for electronically submitting documents for printing, with or without additional pre-processing. In this process submitted documents could be text, images or combinations of the two, formatted or non-formatted.

### Example 5

### Online Proposal Submission to a Patent Office

Various patent offices have launched initiatives to move the patent submission process from an all paper based to an all-electronic submission based process. However, use of the electronic process put in place by the various agencies remain limited and below initial anticipations. One of the reasons for the tepid responses from users has been the relative tediousness of the submission process, the variety of hybrid approaches pursued and the limited incentives to adopt these new processes. The tediousness of the process is due in part to security concerns, the desire to implement a general XML for documents submission in compliance WIPO set standards.

Since XML authoring is not a familiar skill to many potential submitters, various initiatives have been the developed to take commonly used file formats and extract their content. This includes the Patent Application Specification Authoring Tool, or PASAT®, a software application which provides patent authoring support inside the Microsoft® Word framework.

PASAT is built on i4i's (www.i4i.com) S4/TEXT® product, which distinguishes itself in a number of ways. For the USPTO the most important distinguishing characteristic in selecting this product was that it is not an XML authoring tool. Rather, it is a framework for developing complex document authoring support tools that work inside Microsoft Word. XML is part of the framework, not the end game. The PASAT product hides all the XML from the user and provides, through the services of Microsoft Word and the Office Assistant, prompts and guides based on the business rules for creating a patent application. The fact that the S4/TEXT underpinnings to PASAT provide real-time XML support for a complex DTD is totally transparent to the end-user.

However, for any user who has attempted to do productive work with the software, it appears to be highly difficult to use, even for users with significant technical capabilities. This difficulty arises due to the rigidities the software imposes on users when entering specifications. For example to import graphics into the USPTO system, they are required to be TIFF images that must be black and white, 300 dpi Group 4 compression. The requirement is the same for mathematical formulas. This is especially tedious when such graphics or formulas are embedded in the text of specifications. Any reader skilled in the art will easily realize that U.S. Pat. No. 5,787,449 entitled “Method and system for manipulating the content and architecture of a document separately from each other” upon which the USPTO PASAT system is based, is not the most efficient and effective to handle the simplicity and ease of use requirements desirable in an online patent submission process.

So, in addition to being able only to submit proposals only if a Word or WordPerfect application is initially available to the user, the type of graphics that can be handled make the present USPTO online patent submission process quite difficult.

In contrast to the above mentioned prior art, our invention's embodiment for patent submission, as summarized in FIG. 17, achieves the goal of ease of use by allowing a patent office customer to send files from any file format that is in turn converted into a PDF file. Although PDF is a file format developed by a private company, Adobe, it is open for further development to third parties. Adobe, contrary to many people's misgivings, does not control its viewer. Rather, other companies have developed viewers for this file format, including Amyuni Technologies among others. Furthermore, it implements various highly efficient compression algorithms, including the joint Bi-level Image experts Group (JBIG) or ISO/IEC JTC1 SC29 Working Group 2 or JBIG2 compression algorithm. This substantially facilitates document archiving. Using JBIG2 encoding, a scanned image can be compressed up to 10× smaller than with TIFF G4 (see: http://www.cvisiontech.com/pdf_jbig2_info.html).

In selecting a method of submission enabled by our invention and illustrated by FIG. 17, compelling ease of use is achieved, coupled with efficient archiving allowed by JBIG2 compression. Furthermore since PDF text files are easily searchable, the use of the PDF format for document searching and retrieval purposes is more appealing. In addition, secure sharing as implemented using the Webdav (Web-based Distributed Authoring and Versioning) protocol in the AgoraIP website further increase the appeal of our solution.

In summary, our invention when used in a patent submission process provides the following benefits:

1) Universality by allowing submissions from any file type.

2) Ease of use by selecting the PDF format as the file format rendered by the system; furthermore there is exporting potential in custom XML.

3) Secure sharing using the Webdav protocol to facilitate communication within the receiving office and communicating with outside third parties including representatives of the inventor, contractors, representatives of other patent offices.

4) Easy document searching, retrieval and archiving.

This example has shown the benefits of our invention in a patent submission process using the example of the USPTO, however, the advocated architecture can be used in other patent offices as well and our sharing capability are designed to further facilitate interoffice file/folders sharing

### Example 6

### Online Saving and Archiving of Webpages

Another embodiment of the present invention is allowing online saving and archiving of WebPage contents such as online newspapers or filled web forms for future reference. Saving a pure web page with existing prior art technologies has the irritating inconvenience of having to save a web page with a folder of images and possible applications. This makes saved documents tedious and difficult to organize. In an embodiment of our invention, the page is saved as a PDF file preserving all the displayed content and appearance of the page saved, all in a single file document.

### APPENDIX

Example of setup instruction for windows in the Agoraip.com website to show the simplicity of the method outlined:
1. Method: On any windows desktop:
   a. Go to Control Panel.
   b. Click on the Printers and faxes icon.
   c. Click on Add Printer Tasks menu.
   d. A Wizard will appear choose to add a network printer and click next.
   e. When asked to specify a printer, select the Connect to this printer button and enter
   https://secure.agoraip.com:631/printers/PDF-Digitize in the Name box and click Next.
   f. Select Use the specified user account option and enter your account username and password and click Next.
   g. You will be prompted to select a printer driver. You may select a Postcript printer, for example HP Laserjet 5/5M PS. In case this printer driver is not available select any HP printer driver with a Suffix of PS.

What is claimed is:

1. A method for converting, into a PDF file, the printable content of one or more files of any format type from a client computer, said method comprising:
a) sending said printable content to a general file format printer driver, where said printer driver is a printer driver installed on said client computer;
b) converting said printable content into a general format file;
c) sending the general format file of the printable content to a remote server; and,
d) converting the general format file of the printable content into a PDF file using compatible general-file-format-to-PDF-file-conversion software.

2. The method of claim 1 wherein the general format is postscript format.

3. The method of claim 1 wherein step c) comprises sending the general format file electronically using the ipp protocol.

4. The method of claim 1 further comprising enabling the converted PDF file to be saved in a directory.

5. The method of claim 4 wherein accessibility to said directory is limited to authorized users.

6. The method of claim 4 further comprising manipulating said PDF file online to create a new PDF file.

7. The method of claim 6 wherein said online manipulation of said PDF file includes file merging, page insertion, page deletion, text or image hyperlinking, page watermarking, page scaling, file securing.

8. The method of claim 4 further comprising enabling said PDF file to be sent to a chosen printer.

9. The method of claim 8 wherein said chosen printer is selected by a pre-designated user.

10. The method of claim 8 wherein said PDF file is sent to said chosen printer according to a print schedule.

11. The method of claim 8 further comprising enabling said chosen printer to receive said PDF file through file sharing.

12. The method of claim 1 further comprising sending said PDF file to an electronic text or book reader capable of reading PDF files.

13. The method of claim 1 further comprising submitting said PDF file to an institution.

14. The method of claim 13 wherein said institution is a government agency.

15. The method of claim 14 wherein said agency is a patent office.

16. The method of claim 13 wherein said institution is a postal service.

17. The method of claim 13 wherein said institution is a business.

18. The method of claim 17 wherein said business is an online printing business.

19. The method of claim 17 wherein said business is a mail or package delivery service.

20. The method of claim 4 wherein the PDF file is shared among a network of participating parties.

21. The method of claim 20 wherein said PDF file is shared through the webdav protocol.

22. The method of claim 1 wherein the PDF file is further converted into one or more customized XML files, said method comprising
a) extracting text or graphic data from the PDF file content in correspondence with specified XML tags of the customized XML specification
b) inputting said text or graphics data into XML files

23. The method of claim 1 wherein the PDF file is further compressed using various compression algorithms

24. The method of claim 23 wherein the compressed algorithm is the JBIG2 compression algorithm

25. The method of claim 1 wherein the printable content of a) is a Webpage.

26. A system for converting, into a PDF file, the printable content of one or more files of any format type from a client computer, said method comprising:
a) means for sending said printable content to a general file format printer driver, where said printer driver is a printer driver installed on said client computer;
b) means for converting said printable content into a general format file;
c) means for sending the general format file of the printable content to a remote server; and,
d) means for converting the general format file of the printable content into a PDF file using compatible general-file-format-to-PDF-file-conversion software.

27. The system of claim 26 wherein the general format is postscript format.

28. The system of claim 26 wherein step c) comprises sending the general format file electronically using the ipp protocol.

29. The system of claim 26 further comprising means for enabling the converted PDF file to be saved in a directory.

30. The system of claim 29 wherein accessibility to said directory is limited to authorized users.

31. The system of claim 26 further comprising means for manipulating said PDF file online to create a new PDF file.

32. The system of claim 31 wherein said online manipulation of said PDF file includes file merging, page insertion, page deletion, text or image hyperlinking, page watermarking, page scaling, file securing.

33. The system of claim 26 further comprising means for enabling said PDF file to be sent to a chosen printer.

34. The system of claim 33 wherein said chosen printer is selected by a pre-designated user.

35. The system of claim 33 wherein said PDF file is sent to said chosen printer according to a print schedule.

36. The system of claim 33 further comprising means for enabling said chosen printer to receive said PDF file through file sharing.

37. The system of claim 26 further comprising means for sending said PDF file to an electronic text or book reader capable of reading PDF files.

38. The system of claim 26 further comprising means for submitting said PDF file to an institution.

39. The system of claim 38 wherein said institution is a government agency.

40. The system of claim 39 wherein said agency is a patent office.

41. The system of claim 38 wherein said institution is a postal service.

42. The system of claim 38 wherein said institution is a business.

43. The system of claim 42 wherein said business is an online printing business.

44. The system of claim 42 wherein said business is a mail or package delivery service.

45. The system of claim 26 wherein the PDF file is shared among a network of participating parties.

46. The system of claim 42 wherein said PDF file is shared through the Webdav protocol.

47. The system of claim 26 wherein the PDF file is further converted into one or more customized XML files, said system comprising
a) means for extracting text or graphic data from the PDF file content in correspondence with specified XML tags of the customized XML specification
b) means for inputting said text or graphics data into XML files

48. The system of claim 26 wherein the PDF file is further compressed using various compression algorithms

49. The system of claim 48 wherein the compressed algorithm is the JBIG2 compression algorithm

50. The system of claim 25 wherein the original printable content is a Webpage.
